(19) United States
(12) Patent Application Publication
(10) Pub. No.: US 2010/0206449 A1
(43) Pub. Date: Aug. 19, 2010

(54) Vehicle Wheel Having Inner Tire And Outer Tire

(76) Inventor: Seng Gy Jang, Daejeon (KR)

Correspondence Address: GARCIA-ZAMOR INTELLECTUAL PROPERTY LAW;ATTN: RUY GARCIA-ZAMOR, 12960 LINDEN CHURCH ROAD, CLARKSVILLE, MD, 21029, US

(21) Appl. No.: 12/677,678

(22) PCT Filed: Mar. 13, 2008
(86) PCT No.: PCT/KR2008/001408

§ 371 Date: Mar. 11, 2010

(30) Foreign Application Priority Data
Mar. 6, 2008 (KR) 1020080021005

(51) Int. Cl. B60C 5/22

(52) U.S. Cl. 152/340.1

(57) ABSTRACT

The present invention relates to a vehicle wheel having inner and outer tires which can allow a vehicle to be moved to a place of safety or a near service station by forming the inner and outer tires and by maintaining balance and steering control of the vehicle by means of the inner tire positioned inside the outer tire even when the outer tire blows out or gets torn. The vehicle wheel comprises a rim connected with an axle of a vehicle, an outer tire having a large diameter mounted on an outer circumferential surface of the rim and an inner tire having a small diameter positioned inside the outer tire and mounted on the rim, wherein a first air compression chamber formed between the outer circumferential surface of the rim and the inner tire and a second air compression chamber formed between the outer and inner tires.

### TECHNICAL FIELD

The present invention relates to a vehicle wheel fitted to an axle of a vehicle, and more particularly, to a vehicle wheel having inner and outer tires can allow a vehicle to be moved to a place of safety or a service center the vehicle will reach without loss of balance and steering control by means of the inner tire even when the outer tire gets torn or blows out.

### BACKGROUND ART

A conventional vehicle tire has two kinds of tire, in other words, a tubeless and a tube tire. The tires obtain their elasticity from injecting air into the tires. FIG. 4 shows a state in which a conventional tubeless tire 100 is mounted on a rim.

However, when the tire 100 blows out or gets torn, a vehicle loses its balance and steering control suddenly, thus the vehicle brings about a traffic accident due to lane departure or a large traffic accident due to rollover of the vehicle. In addition, a tire or a tube is damaged from contacting a wheel to a road surface directly.

A technology has been generally known to fill a filler inside the conventional vehicle tire or to add an air layer to the tire to solve the above-described problem.

Korean Patent Publication No. 1995-0026705 describes a dual wheel for vehicle and its vehicle wheel, which is configured to form two compressed air chambers by forming a rubber tire separately with two tires and by mounting the tires on one dual wheel. Additionally, it is indicated to reduce danger of rollover due to a sudden change of the center of gravity by allowing any one chamber to stably support a vehicle body even when compressed air of the other chamber is leaked due to partial damage to the tire. However, the prior art has problems resulting in making the structure of the wheel excessively complicated and change of the wheel uneasy.

### DISCLOSURE OF INVENTION

### Technical Problem

Accordingly, the present invention is invented so as to solve the above problem of the prior art. An object of the present invention is to provide a vehicle wheel having inner and outer tires that can allow a vehicle to be moved to a place of safety or a near service station by forming the inner and outer tires and by maintaining balance and steering control of the vehicle by means of the inner tire positioned inside the outer tire even when the outer tire blows out or gets torn.

Another object of the present invention is to provide a dual tire, divided into inner and outer tires, which can be used as a general tire.

### Technical Solution

According to an aspect of the present invention, there is provided a vehicle tire having inner and outer tires which includes a rim fitted to an axle of a vehicle, an outer tire having a large diameter mounted on an outer circumferential surface of the rim and an inner tire having a small diameter, positioned inside the outer tire and mounted on the rim, wherein a first air compression chamber is formed between the outer circumferential surface of the rim and the inner tire and a second air compression chamber is formed between the outer tire and the inner tire.

### Advantageous Effects

The vehicle wheel having the inner and outer tires, wherein the outer tire is contacted to the road surface while rotating and the inner tire is installed inside the outer tire to be protected by the outer tire, according to present invention produces the following effects.

First, it can allow a vehicle to be moved to a place of safety or a service station by allowing the inner tire to maintain balance and steering control of the vehicle when the outer tire blows out or gets torn.

Second, it can be used as a general tire by applying the configuration according to the present invention without special remodeling as described above.

Third, it can prevent the outer tire from being damaged or broken when the vehicle is running by preventing the outer tire from being directly contacted to the rim.

### BRIEF DESCRIPTION OF THE DRAWINGS

The following drawings show preferred embodiments of the present invention. The detailed descriptions of the present invention will be more apparent, taken in conjunction with the detailed explanations to be described below. However, the present invention is not limited to the details in the drawings.

FIG. 1 is a front view illustrating a vehicle wheel having inner and outer tires according to the present invention;

FIG. 2 is a cross-sectional view, taken along a line of A-A of FIG. 1;

FIG. 3 is a view illustrating a state in which an outer tire blows out positioned inside the wheel having inner and outer tires according to the present invention; and

FIG. 4 is a cross-sectional view illustrating that a conventional tubeless tire is mounted.

### DESCRIPTION OF REFERENCE NUMBERS RELATED TO MAIN PARTS IN DRAWINGS

10: rim
12: circular projection rib
20: outer tire
30: inner tire
32: interval maintaining unit
40: first air compression chamber
50: second air compression chamber
60: first air injection valve
62: second air injection valve

### Mode for the Invention

Hereinafter, preferred embodiments of the present invention will be described in detail with reference to the accompanying drawings.

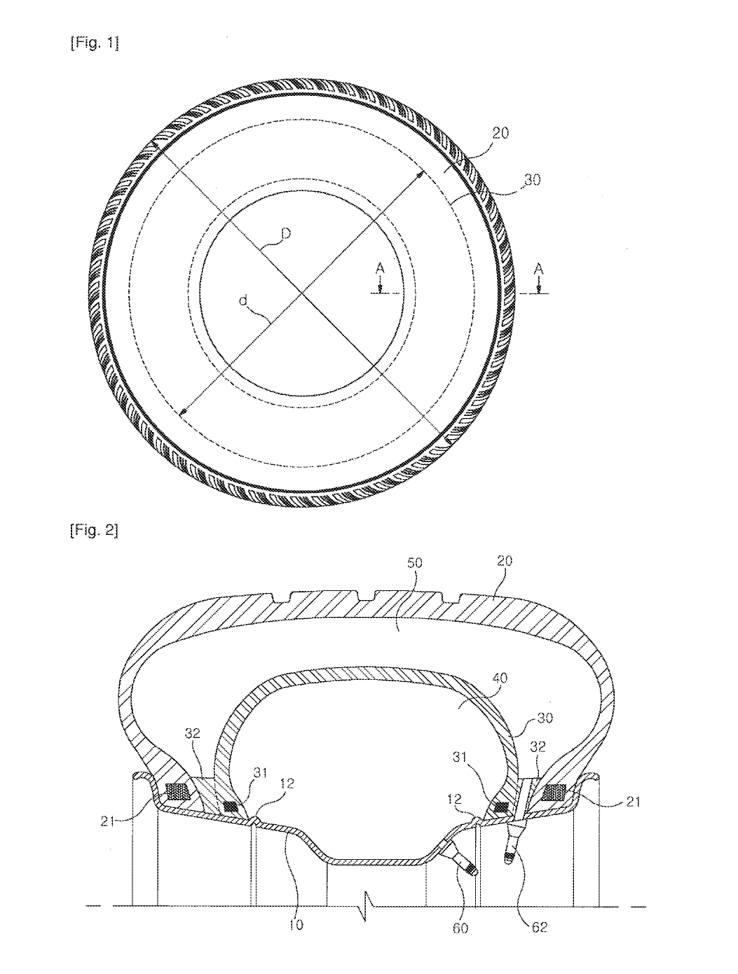

Referring to FIGS. 1 and 2, a rim 10 is fitted to an axle of a vehicle. The rim 10 is made of a metal material, but not limited to a cross-sectional shape shown in FIG. 2. An outer tire 20 having a large diameter (D) is mounted on an outer circumferential surface of the rim 10 and an inner tire 30 having a small diameter (d) mounted on the rim 10 is mounted inside the inner tire 30. In this time, the inner tire 30 may have the same cross-sectional structure as that of the outer tire 20, or, may have a cross-sectional structure similar or different from the outer tire 20.

A first air compression chamber 40 is formed between the outer circumferential surface of the rim 10 and the inner tire 30 and a second air compression chamber 50 is formed between the outer tire 20 and the inner tire 30. In this time, the inner tire 30 may have a tube (not shown) or be tubeless. The inner tire 30 having the tube allows the first air compression chamber to be an inner side of the tube. The outer and inner tires 20 and 30 are made of the same material, rubber, as that of a general vehicle tire and equipped with lead wires 21 and 31 respectively.

A first air injection valve 60 is installed on the rim to inject compressed air into the first air compression chamber 40. When the inner tire 30 has the tube, the first air injection valve 60 is connected with the tube.

In addition, a second air injection valve 62 is installed on the rim to inject compressed air into the second air compression chamber 50 and generate a tire pressure in the outer tire 20. In this time, an interval maintaining unit 32 contacted to an inner circumferential surface of the outer tire 20 is formed by being further extended on an outer circumferential surface of the inner tire 30.

The interval maintaining unit 32 allows the inner and outer tires 30 and 20 to be spaced from each other to divide the inner and outer tires 30 and 20 and has a thickness for maintaining an interval between the inner and outer tires 30 and 20. In addition, the interval maintaining unit 32 allows air to be injected into the second air compression chamber 50 by installing the second air injection valve 2 through the interval maintaining unit 32. In other words, the second air injection valve 62 passing through the rim 10 allows air to be injected through the interval maintaining unit 32 by forming an air path along the interval maintaining unit 32.

Additionally, a circular projection rib 12 is formed on the outer circumferential surface of the rim 10 to fix an installation position of the inner tire 30. The projection rib 12 is formed along the rim 10 to support the inner tire 30, thereby maintaining balance control of the inner tire 30 and preventing the inner tire 30 from being separated from the rim 10.

Now, the operation of the preferred embodiments will be explained in detail.

Referring to FIG. 1, in a state which the inner and outer tires 30 and 20 are mounted on the rim 10, compressed air is injected into the first air compression chamber through the first air injection valve 60. Accordingly, the inner tire 30 is inflated and has an adequate tire pressure.

In this time, the projection rib 12 formed along the rim 10 prevents the inner tire 30 from being slipped and separated from a position the inner tire 30 is inflated.

In this state, compressed air is injected into the second air compression chamber 50 through the second air injection valve 62. Accordingly, the outer tire 20 is inflated and has an adequate tire pressure.

The second air injection valve 62 is installed along the interval maintaining unit 32 formed between the outer and inner tires 20 and 30. As a result, air is injected through the interval maintaining unit 32 without other air injection path, and the inner and outer tires 30 and 20 have an inflated space to be independent to each other by the interval maintaining unit 32, when the outer and inner tires 20 and 30 are filled with air respectively.

The first and second air compression chambers 40 and 50 may allow the same tire pressure to be generated. Likewise, the outer and inner tires 20 and 30 are filled with the tire pressure and thus the following operation is obtained. When the outer tire 20 gets torn or blows out due to vehicle driving, the air injected into the second air compression chamber 50 is leaked out.

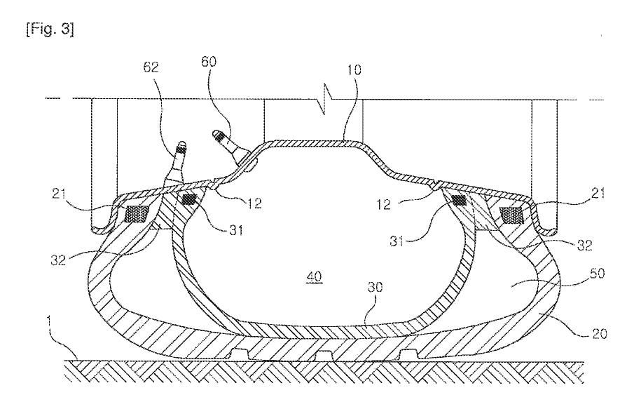

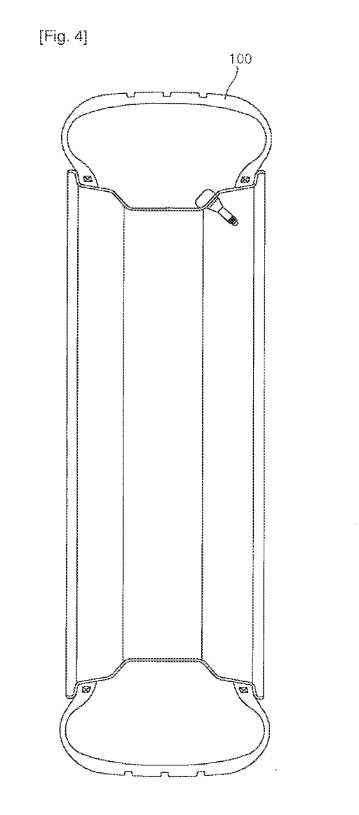

Accordingly, the outer tire 20 is not contacted to the rim 10 but to the inner tire 30 as shown in FIG. 3 even when the vehicle is collapsed on a road surface due to load of the vehicle. In other words, the inner tire 30 prevents the inner tire 30 from contacting the outer tire 20 to the rim 10 between the outer tire 20 and the rim 10. As a result thereof, the inner tire 30 can prevent the wheel from being damaged even when the outer tire 20 is contacted to a road surface.

Additionally, even when the outer tire 20 blows out, the inner tire 30 maintains contact to the road surface by the tire pressure, thereby maintaining the vehicle well-balanced and its steering control. As a result thereof, it can allow the vehicle to be moved to a place of safety or a service station by driving the vehicle continuously.

When the damaged outer tire 20 gets partially torn, the outer tire 20 is totally changed. In addition, the outer tire 20 blows out, a blow-out portion of the outer tire 20 is repaired and then compressed air is injected through the second air injection valve 62 into the outer tire 20, thus the repairing is completed.

1-4. (canceled)

5. A vehicle wheel having inner and outer tires, comprising:
a rim connected with an axle of a vehicle;
an outer tire having a large diameter mounted on an outer circumferential surface of the rim and an inner tire having a small diameter positioned inside the outer tire and mounted on the rim;
wherein a first air compression chamber is formed between the outer circumferential surface of the rim and the inner tire and a second air compression chamber is formed between the outer tire and the inner tire, the rim comprises a first air injection valve for injecting compressed air into the first air compression chamber and a second air injection valve for injecting compressed air into the second air compression chamber, an interval maintaining unit is formed between the outer and inner tires by allowing the outer and inner tires to be spaced from each other to divide the outer and inner tires, the interval maintaining unit has a thickness to be contacted to an inner circumferential surface of the outer tire on the outer circumferential surface of the inner tire to maintain an interval between the inner and outer tires, a second air injection valve is installed on the interval maintaining unit and is configured to inject air into the second air compression chamber.

6. The vehicle wheel of claim 5, wherein a circular projection rib is formed on the outercircumferential surface of the rim to fix an installation position of the inner tire, the projection rib is projected along the rim to support the inner tire so as to maintain balance control of the inner tire and to prevent the inner tire from being separated from the rim.
